(19) United States
(12) Patent Application Publication
(10) Pub. No.: US 2004/0257219 A1
(43) Pub. Date: Dec. 23, 2004

(54) Computer security alert system

(76) Inventors: David M. Spiess JR., Milford, OH (US); Dwayne C. Bullock, Xenia, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 10/825,970

(22) Filed: Apr. 16, 2004

Related U.S. Application Data
(60) Provisional application No. 60/463,282, filed on Apr. 16, 2003.

(51) Int. Cl. G08B 1/00

(52) U.S. Cl. 340/531; 709/224

(57) ABSTRACT

The present invention provides a system and method for alerting a user of an occurrence on a computerized system, beginning with the recognition of any detectable occurrence on the computerized system. The detectable occurrence that initiates a communication of a signal to a communication port located on that computerized system. The port then routes the signal via a connection to an alarm-relay device, and this alarm-relay device designates the appropriate relay to initiate processes of an existing residential alarm system.

### CROSS REFERENCE TO RELATED APPLICATIONS

The present application claims the benefit of U.S. Provisional Application, Ser. No. 60/463,282, filed Apr. 16, 2003, the disclosure of which is incorporated herein by reference.

### BACKGROUND

1. Field of the Invention

The field of the present invention is computer related security applications. More specifically, the present invention relates to methods for monitoring, detecting, and alerting the user of occurrences on a computer or computerized device, without necessitating use of a computer network, via communications between the computer/device, an alarm-relay device, and an existing alarm system, such as a residential alarm system.

2. The Prior State of the Art

The idea behind the most basic security alarm system is to protect an object by creating a sensor that will monitor the object and alert the owner of any breaches of security. Among the earliest and most familiar devices of general application were conventional residential security systems including intrusion detecting devices, such as door and window contacts located in houses or offices. These residential security systems have been used for many years and are simple in design, consisting of a security system that monitors various sensors/contacts for different objects and detects any breaches of security within the house or office. Any breach of security may automatically initiate an auditory or visual alarm and may also be reported to the security alarm company, typically using telephone lines, who may then notify the homeowner/business-owner and/or the police or fire-department of the security breach. This type of residential security system has satisfied consumers looking to protect their home or business, but not computers or computerized devices therein.

Over the years, applications for security systems to monitor various objects has diversified with increasing technological advances. For example, a homeowner or business owner can monitor and control a variety of devices in their home or office from a distant location via a communications link between a central data center and/or a global computer network. Unfortunately, most of these security systems are highly dependent upon the functionality of a global computer network. For example, it is not uncommon for an internet connection to fail due to a number of reasons, such as a fallen cable wire, bad weather, or a simple lapse in signal strength. Furthermore, there is no way to predict the time period that a household will be out of internet service, which could range from minutes to days.

Moreover, the increase in technology of automation devices necessitates the ability to monitor multiple devices, and to find ways of connecting them together. If a homeowner or business owner wished to protect objects within his/her home or office, his/her options are limited to purchasing a new security alarm system to monitor the objects. Having more than one security alarm system in a house or office may be cumbersome and the cost of monitoring twenty-four (24) hours a day, seven (7) days a week, and three hundred and sixty-five (365) days a year may not be worth the added security. A new house or office undergoing construction may not face the problems of interconnecting a security system to various other devices, however, all other houses and offices face a problem of finding a security system that may be utilized by a multitude of different devices and the tedious job of possibly rewiring an entire house or office.

Some prior art attempt to unify home or office automation systems with the aid of using a personal computer for monitoring and controlling various devices in place of a dedicated control panel. Using a personal computer may be beneficial because the house or office may already have a computer and the homeowner or business owner may already be familiar with using various software on the computer. Unfortunately, these devices may not provide security alert functions and are not readily able to capitalize on already existing security alarm systems, such as the services provided by ADT, Protect America, etc. The companies claiming these prior art inventions also use their own equipment to control the monitoring and controlling, and such equipment is costly, proprietary and only work on personal computers. There exists a universal need for a more efficient, cost effective and improved manner for safeguarding computerized devices twenty-four (24) hours a day, seven (7) days a week, and three hundred and sixty-five (365) days a year.

### SUMMARY

In light of the foregoing problems in the prior state of the art, such shortcomings have been successfully solved by the present invention, which is directed to methods that allow for the monitoring and detection of occurrences on computers or computerized devices (“computer systems”) by capitalizing on conventional security alarm systems, such as residential alarm systems. This invention is especially useful due to the increasing need to monitor and secure computerized systems available in residential and commercial settings, such as personal computers, laptops, copy machines, cell phones, PDA's, fax machines, firewalls, printers, etc. Furthermore, the creation of this invention, which allows a person to monitor their computerized belongings on the same security system that monitors and protects their home or office, is not reliant upon the unreliable working status of a global computer network and monitors and protects twenty-four (24) hours a day, seven (7) days a week, and three hundred and sixty-five (365) days a year.

It is therefore a first aspect of the invention to provide a system and method of alerting a user of an occurrence on a computerized system. The method includes the steps of: detecting the occurrence on the computerized system; transmitting a signal indicative of the occurrence from the computerized system to an alarm-relay device; and communicating the signal from the alarm-relay device to a residential alarm system. In a more detailed embodiment, the computerized system is a computerized system having a communication port, and the signal is transmitted from the computerized system to the alarm-relay device via the communications port. This communication port can be, for example, a serial port, a USB port, an infrared port, a parallel port or like ports.

The system can be, for example, a personal computer system. In such a case, the occurrence, for example, may be an alert that power to the computer system has been terminated or disrupted, may be an alert that a virus has been detected, may be an alert that critical heat levels have been reached, or may be an alert that unauthorized use of computer programs has occurred.

The system may also be a copying machine. In such a case, the occurrence, for example, may be an alert that toner is low, may be an alert that a paper jam has occurred, or may be an alert that the paper drawer needs to be refilled.

The system may also be, for example, a personal digital assistant, a cell phone, a printer, or a firewall, each having the ability to detect the occurrence.

In an alternate detailed embodiment of the first aspect of the present invention, the method may further include a step of sending a validation sequence to the alarm-relay device prior to the transmitting step. In a further detailed embodiment, the validation sequence includes a key sequence.

In another alternate detailed embodiment of the first aspect of the present invention, the communication of the signal from the alarm-relay device to an alarm system is not reliant upon an internet connection with a global computer network. And in a further detailed embodiment, the alarm system is a conventional, residential security alarm system.

It is a second aspect of the present invention to provide a system and method for alerting a user of an occurrence on a computerized system. The method includes the steps of: continuously transmitting a still-alive signal from a computerized system to an alarm-relay device on a pre-defined schedule; and upon not receiving said still-alive signal from said computerized system according to said pre-defined schedule, communicating an alert signal from said alarm-relay device to a residential alarm system.

It is a third aspect of the present invention to provide a system and method for alerting a user of an occurrence on a computerized system. The method includes the steps of: detecting the occurrence on the computerized system; transmitting a signal indicative of the occurrence from the computerized system to an alarm-relay device; and communicating the signal from the alarm-relay device to an alarm system, where the alarm-relay device is not coupled to either of the monitoring system and the alarm system by a computer network.

It is a fourth aspect of the present invention to provide a system and method for alerting a user of an occurrence on a personal computer system. The method includes the steps of detecting the occurrence on the personal computer system having a serial port and a still-alive function; transmitting a signal indicative of the occurrence from the computerized system to an alarm-relay device via an attached cable; communicating the signal from the alarm-relay device to an alarm system, where the alarm-relay device is not coupled to either of the monitoring system and the alarm system by a computer network; and sending a validation sequence and a key sequence to the alarm-relay device prior to the transmitting step.

### BRIEF DESCRIPTION OF THE DRAWINGS

FIG. 1 is a schematic representation of an exemplary system according to the present invention;

FIG. 2 is layout view of an alarm-relay device housing according to an exemplary embodiment of the present invention; and

FIG. 3 is a wiring diagram for the alarm-relay device according to an exemplary embodiment of the present invention.

### DETAILED DESCRIPTION

The present invention provides a system and method for alerting a user of an occurrence on a computer or a any device that has a microcontrooler, EEPROM, or other similar controller (collectively, a “computer system” or a “computerized system”), beginning with the recognition of any detectable occurrence on the computerized system.

As shown in FIG. 1 an exemplary embodiment of the present invention provides an alarm relay device 10 operatively coupled between a computer system 12 and a conventional residential alarm system 14 of a residence/business 16. The residential alarm system 14, in this exemplary embodiment communicates with a central security service 18 over standard telephone lines 20. Of course, it is within the scope of the invention that the residential alarm system 14 communicate with the central security service 18 using other known communication schemes. The central security service 18 will communicate with the owner/user of the residence/business 16 and/or computer system 12, and to police or other authorities, through any standard procedure and systems available to conventional residential alarm systems. In the exemplary embodiment, the alarm relay device 10 is not coupled to the Internet or a similar computer network, nor does it utilize the Internet (or similar computer network) for any of its critical communications (i.e., with the computer system 12 or with the central security service 18).

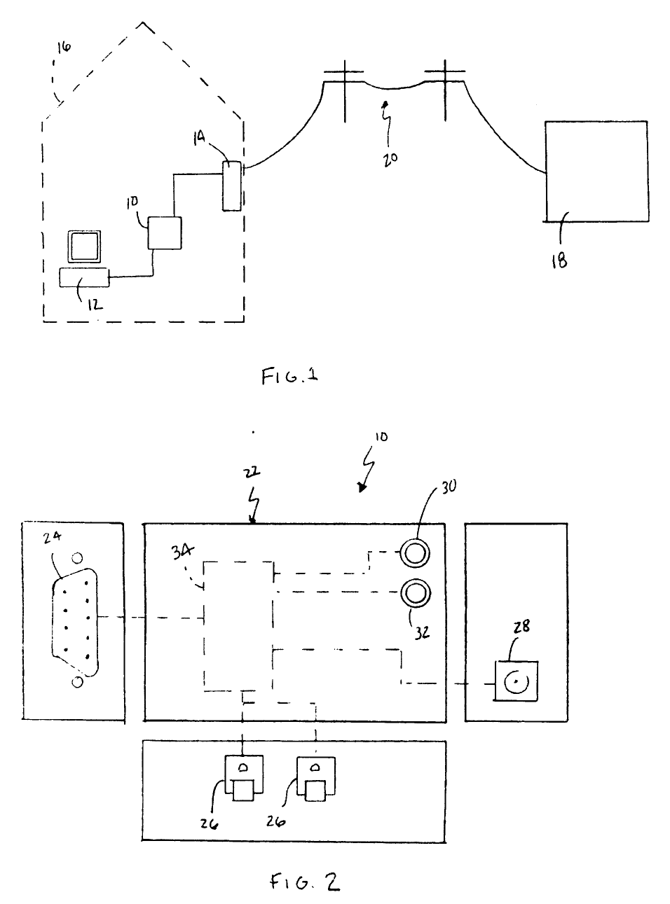

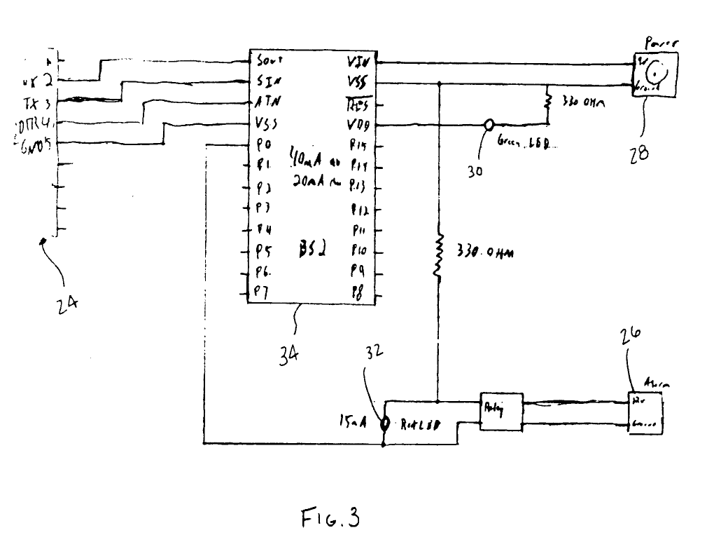

Referring to FIGS. 2 and 3, the alarm-relay device 10 includes a housing 22 that contains a computer system communications port 24, an alarm system communication port 26, a power connector 28, a green LED light 30 and a red LED light 32. The green LED light 30 is used indicate that the alarm-relay device 10 is powered on and ready for use, while the red LED light 32 indicates that there is an alarm in progress. While the exemplary embodiment of the invention uses a serial connector as the computer system communications port 24 (for coupling to a serial port of the computer system 12) it will be appreciated that other types of communications ports and/or data connections may be used, such, for example, as USB port, an infrared port, a parallel port, or a Bluetooth connection. The exemplary embodiment has been configured to enable simple customization to utilize any free or available communication port on the computer system 12.

Within the alarm-relay device 10 resides a microcontroller chip 34, such as a Basic Stamp II chip, a Basic Stamp I chip, or another similar microcontroller chip. The microcrontroller chip 34 is operatively coupled between the computer system communications port 24, alarm system communications port 26 and LED lights 30, 32. See FIG. 3 for an exemplary wiring diagram. Technological advances for these microcontroller chips are so rapid, that the exemplary embodiment of the alarm-relay device would be the least obtrusive, least expensive, least power consuming, and most readily adaptable chip available at the time of manufacture. All mechanical and electrical values, such as resistors, appropriate relay devices, and other considerations are highly dependent on the type of microcontroller chip used for the alarm-relay device, however, one skilled in the art would be able to adjust these values to the particular microcontroller chip used without undue burden.

In the exemplary embodiment, the power connector 28 would be a barrel power connector that would simply plug into a conventional household electrical outlet of the standard twelve (12) or nine (9) Volts. As stated above, all mechanical and electrical values of the alarm-relay device would be adjusted accordingly.

The mechanisms 26 for communicating the alarm-relay device 10 to an existing security alarm system 14 could include a multitude of different adaptors, such as a two (2) wire, spring loaded connector, a telephone wire connector, a radio frequency connector, a screw connector, or any other standard electrical communication device.

The present invention uses at least two software programs, one residing on the computer system 12 and one residing on the microcontroller chip 34. The software residing on the computer system 12 is designed for any computerized system to first detect and then to send an alert to the alarm relay device 10 over the communication port 24. This software is specially tailored to the computerized system's operating system or related operational software. For example, if the computerized system 12 is a personal computer that is running a Windows program, then the software would be written specifically to accommodate the language that Windows uses. If the system used was a copy machine, a fax machine, a firewall, or a cable box, the software would be written to match the specific language of that device.

The software residing on the microcontroller chip 34 is generally configured to detect and process an alert received on the computer system communication port 24, and to generate an appropriate alarm or appropriate notification to the alarm system 14 over the communication port 26.

A detectable occurrence could be an alert that a personal computer has just been infected by a virus or has reached critical heat levels, or that a firewall has been compromised, or that a copy machine is out of toner or has malfunctioned. In this case, the occurrence would initiate the alert to the alarm-relay device 10, which would then relay the alert to the existing security alarm system 14. Additional alarms or alerts include, for example, and without limitation: an alert that power to the computer system 12 has been terminated or disrupted, an alert that a virus has been detected, an alert that critical heat levels have been reached, and an alert that unauthorized use of computer programs has occurred.

The computerized system 12 may also be a copying machine. In such a case, the occurrence, for example, may be an alert that toner is low, may be an alert that a paper jam has occurred, or may be an alert that the paper drawer needs to be refilled.

The computerized system 12 may also be, for example, and without limitation, a personal digital assistant, a cell phone, a printer, or a firewall, network equipment, a fax machine, a cable box, a manufacturing system such as a robotic system, and an automated system, each having the ability to detect the occurrence and relay that occurrence to the alarm-relay device 10.

A discontinuance of a “still-alive” communication between the computerized system 12 and the alarm-relay device 10 may also constitute a detectable occurrence worthy of an alert to the owner. In this case, the still-alive message is a simple on/off message that is sent on a pre-set time interval, and merely serves the function of notifying the alarm-relay device 10 that everything is functioning properly. However, if the computerized system 12 were to experience an unexpected power failure or interruption (or any other occurrence that would substantially disable the computer system 12), the still-alive function would be disabled and the alarm-relay device would relay such a message to the existing security alarm system 14 when it fails to receive its schedule still-alive notification from the computer system 12.

In the exemplary embodiment, before the computerized device 12 uses the communications port 24 to transmit an alert message to the alarm-relay device 10, a key sequence is first transmitted to validate the alert message. This key sequence may be a simple code that is programmed in the software, which verifies that the alert message is valid and is not simply a lapse in signal or a false transmission. This key sequence ensures that a possible lapse in the still-alive function or a mistaken detection of an occurrence does not needlessly initiate the alarm-relay device and does not falsely notify the existing security alarm system.

After the key sequence is transmitted and the alert message is sent, the information is received by the microcontroller chip 34 in the alarm-relay device 10, and the appropriate relay is initiated. In the exemplary embodiment, the appropriate relay is communicated by the alarm-relay device 10 to the existing security alarm system 14 by means of a connection with the two (2) wire, spring loaded adapter and the wiring of the existing security alarm system. The message to the existing security alarm system depends upon which zone the wires from the alarm-relay device were connected. Due to the fact that most eight (8) bit microcontroller chips can handle approximately two-hundred and fifty-six (256) zones, the homeowner or business owner may be able to program up to 256 different alarms or messages. Certainly, different microcontrollers (or combinations of microcrontrollers) may be able to handle different combinations and quantities of zones.

Once the alarm or message is received by the central security service 18, the homeowner or business owner has the option of instructing the service to call the police, notify the owner, or to complete any other pre-determined instructions. For example, if the residence 16 were a business, the central security service 18 could be an IT department, or the central security service 18 could be instructed to contact the IT department, a contractor or a vendor, for example. This 3^{rd} party verification may be important for documentation purposes.

Following from the above description and invention summaries, it should be apparent to those of ordinary skill in the art that, while the systems and processes herein described constitute exemplary embodiments of the present invention, it is understood that the invention is not limited to these precise systems and processes and that changes may be made therein without departing from the scope of the invention as defined by the following claims. Additionally, it is to be understood that the invention is defined by the claims and it is not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method of alerting a user of an occurrence on a computerized system, said method comprising the steps of:
detecting said occurrence on said computerized system;
transmitting a signal indicative of said occurrence from said computerized system to an alarm-relay device; and
communicating said signal from said alarm-relay device to a residential alarm system.

2. The method as recited in claim 1, wherein said computerized system is a computerized system having a communication port, and wherein said signal is transmitted from said computerized system to said alarm-relay device via said communications port.

3. The method as recited in claim 2, wherein said communication port is taken from a group consisting of a serial port, a USB port, an infrared port, and a parallel port.

4. The method as recited in claim 1, wherein said system is a personal computer system having the ability to detect said occurrence.

5. The method as recited in claim 4, wherein said occurrence is an alert that power to said personal computer system has been terminated or disrupted.

6. The method as recited in claim 4, wherein said occurrence is an alert that a virus has been detected.

7. The method as recited in claim 4, wherein said occurrence is an alert that critical heat levels have been reached.

8. The method as recited in claim 4, wherein said occurrence is an alert that unauthorized use of computer programs has occurred.

9. The method as recited in claim 1, wherein said system is a laptop computer system having the ability to detect said occurrence.

10. The method as recited in claim 1, wherein said system is a copying machine having the ability to detect said occurrence.

11. The method as recited in claim 10, wherein said occurrence is an alert that toner is low.

12. The method as recited in claim 10, wherein said occurrence is an alert that a paper jam has occurred.

13. The method as recited in claim 10, wherein said occurrence is an alert that the paper drawer needs to be refilled.

14. The method as recited in claim 1, wherein said system is a personal digital assistant having the ability to detect said occurrence.

15. The method as recited in claim 1, wherein said system is a cell phone having the ability to detect said occurrence.

16. The method as recited in claim 1, wherein said system is a printer having the ability to detect said occurrence.

17. The method as recited in claim 1, wherein said system is a firewall having the ability to detect said occurrence.

18. The method as recited in claim 1, further comprising a step of sending a validation sequence to said alarm-relay device prior to said transmitting step.

19. The method as recited in claim 18, wherein said validation sequence includes a key sequence.

20. The method as recited in claim 1, wherein said signal is transmitted over an attached cable.

21. The method as recited in claim 1, wherein said signal is transmitted over a wireless connection.

22. The method as recited in claim 1, wherein said communication of said signal from said alarm-relay device to an alarm system is not reliant upon an internet connection with a global computer network.

23. The method as recited in claim 22, wherein said alarm system is a conventional, residential security alarm system.

24. A method of alerting a user of an occurrence on a computerized system, said method comprising the steps of:
continuously transmitting a still-alive signal from a computerized system to an alarm-relay device on a pre-defined schedule; and
upon not receiving said still-alive signal from said computerized system according to said pre-defined schedule, communicating an alert signal from said alarm-relay device to a residential alarm system.

25. A method of alerting a user of an occurrence on a computerized system, said method comprising the steps of:
detecting said occurrence on said computerized system;
transmitting a signal indicative of said occurrence from said computerized system to an alarm-relay device; and
communicating said signal from said alarm-relay device to an alarm system, wherein said alarm-relay device does not communicate with either of the monitoring system and the alarm system by a computer network.

26. A method of alerting a user of an occurrence on a personal computer system, said method comprising the steps of:
detecting said occurrence on said personal computer system;
transmitting a signal indicative of said occurrence from said computerized system to an alarm-relay device via an attached cable;
communicating said signal from said alarm-relay device to an alarm system, wherein said alarm-relay device does not communicate with either of the monitoring system and the alarm system using the Internet; and
sending validation data from said personal computer system to said alarm-relay device prior to said transmitting step.
